(19) United States
(12) Patent Application Publication
(10) Pub. No.: US 2024/0273870 A1
(43) Pub. Date: Aug. 15, 2024

(54) SELF-SUPERVISED DOMAIN ADAPTATION IN CROWD COUNTING

(71) Applicant: BOARD OF TRUSTEES OF THE UNIVERSITY OF ARKANSAS, Little Rock, AR (US)

(72) Inventors: Khoa Luu, Fayetteville, AR (US); Anh Pha Nguyen, Fayetteville, AR (US); Yi Liang, Fayetteville, AR (US); Miaoqing Huang, Fayetteville, AR (US)

(73) Assignee: BOARD OF TRUSTEES OF THE UNIVERSITY OF ARKANSAS, Little Rock, AR (US)

(21) Appl. No.: 18/438,089

(22) Filed: Feb. 9, 2024

Related U.S. Application Data
(60) Provisional application No. 63/444,890, filed on Feb. 10, 2023.

(51) Int. Cl. G06V 10/771; G06T 7/194; G06V 10/764

(52) U.S. Cl. CPC G06V 10/771; G06T 7/194; G06V 10/764

(57) ABSTRACT

Systems and methods for training a network via a source domain of labeled image samples and a target domain of unlabeled image samples are disclosed. The method includes determining, for each domain of the source domain and the target domain, an entropy loss related to the domain, determining an adversarial loss for a domain discriminator configured to predict whether a given input belongs to the source domain or the target domain, and executing domain adaptation training of the network using the entropy loss for the source domain, the entropy loss for the target domain, and the adversarial loss.

### CROSS-REFERENCE TO RELATED APPLICATIONS

This application claims priority to U.S. Provisional Patent Application No. 63/444,890, filed on Feb. 10, 2023. The entirety of the aforementioned application is incorporated herein by reference.

### STATEMENT REGARDING FEDERALLY SPONSORED RESEARCH

This invention was made with government support under 1946391 awarded by the National Science Foundation. The government has certain rights in the invention.

### BACKGROUND

Crowd counting has recently been a popular task in computer vision. Despite many advances, this is one area still largely reliant on manual labor, for example, often by requiring an extensive annotation of thousands of images.

### SUMMARY

In an embodiment, the present disclosure pertains to a method of training a network via a source domain of labeled image samples and a target domain of unlabeled image samples. The method includes determining, for each domain of the source domain and the target domain, an entropy loss related to the domain, determining an adversarial loss for a domain discriminator configured to predict whether a given input belongs to the source domain or the target domain, and executing domain adaptation training of the network using the entropy loss for the source domain, the entropy loss for the target domain, and the adversarial loss.

In another embodiment, the present disclosure pertains to a system having a processor and memory. The processor and memory in combination are operable to perform a method of training a network via a source domain of labeled image samples and a target domain of unlabeled image samples. The method includes determining, for each domain of the source domain and the target domain, an entropy loss related to the domain, determining an adversarial loss for a domain discriminator configured to predict whether a given input belongs to the source domain or the target domain, and executing domain adaptation training of the network using the entropy loss for the source domain, the entropy loss for the target domain, and the adversarial loss.

In an additional embodiment, the present disclosure pertains to a computer-program product having a non-transitory computer-usable medium having computer-readable program code embodied therein, the computer-readable program code adapted to be executed to implement a method for training a network via a source domain of labeled image samples and a target domain of unlabeled image samples. The method includes, for each domain of the source domain and the target domain, extracting a feature map related to one or more image samples of the domain, estimating an offset map and a classification map given the feature map, and determining an entropy loss related to the domain using information related to the classification map. The method further includes, determining an adversarial loss for a domain discriminator configured to predict whether a given input belongs to the source domain or the target domain and executing domain adaptation training of the network using the entropy loss for the source domain, the entropy loss for the target domain, and the adversarial loss. The domain discriminator is trained to produce fault predictions.

### BRIEF DESCRIPTION OF THE DRAWINGS

A better understanding of the present invention can be obtained when the following detailed description is considered in conjunction with the following drawings, in which:

FIGS. 1A and 1B illustrate a method (FIG. 1A) and a computing device (FIG. 1B) for training a network via a source domain of labeled image samples and a target domain of unlabeled image samples, according to aspects of the present disclosure.

FIG. 2 illustrates an example framework for self-supervised domain adaptation by entropy minimization and adversarial learning, according to aspects of the present disclosure.

FIG. 3 illustrates qualitative results on a chicken dataset with different domain adaptation training strategies (from top to bottom: entropy minimization loss; adversarial loss; both the losses).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Crowd counting presents numerous challenges. For example, manually observing individual chickens in commercial broiler production housing systems has become a tedious and demanding job. From laying hens to broiler chickens, there are numerous problems when housing chickens in large groups and at high density, including respiratory symptoms, bacterial infections, lameness in broilers, and feather-pecking where a chicken will peck at the feathers of another chicken and cause injuries, and the like. Early detection of abnormal behaviors of the chickens aids in the optimization of growth performance.

Vision-based crowd counting, tracking, and behavior analysis systems using advanced computer vision and machine learning methods have gained popularity over the years to automatically locate subjects and analyze location-based data for behavioral research. Following this trend, automated tracking and behavior understanding systems have become useful in quickly identifying individual abnormal chickens in large groups for populational and behavioral analysis. Tracking results of the behavior analysis can be integrated with environmental and production monitoring.

Crowd counting has recently been one of the popular tasks in computer vision. Recent developed methods and datasets have been introduced to tackle counting tasks with thousands of targets. However, in real-world scenarios, fully supervised deep learning methods usually learn to predict through a training process that requires an extensive annotation of densely populated subjects in thousands of images. Directly employing deep learning models that are trained on existing datasets to a new dataset suffers from a significant performance decrease due to the domain gap, for example, gaps in context, characteristics, and constraints of the datasets. Despite the many advances in poultry science, this is one area still largely reliant on manual labor by requiring an extensive annotation of densely populated chicken in thousands of images.

Therefore, in addition to semantic scene understanding and video temporal modeling, some self-training methods appear to utilize existing datasets with labels (i.e., source domain), and perform counting on more open-set scenarios (i.e., target domain), by transfer learning and domain adaptation techniques. While general self-learning methods improve the generalization capability by attempting to estimate pseudo ground-truths or distillation learning from a teacher network, few approaches investigate a new direction to narrow the domain shift from entropy feedback of the target domain, especially in the semantic segmentation task.

In various embodiments, the artificial intelligence systems described herein directly solve the above problems and have the ability to continually learn to count notwithstanding new farm scenes, new species, and new population-level variation. Therefore, aspects of the present disclosure relate to a new training approach to the crowd counting task toward a domain adaptation setting where the deep learning algorithm utilizes entropy minimization and adversarial learning to alleviate the distributional discrepancy between the source domain and the target domain.

The present disclosure describes examples of a novel framework for self-supervised domain adaptation by entropy minimization and adversarial learning. Inspired by anchor-based and offset-based detection approaches, aspects of the present disclosure reformulate the crowd counting problem from normally estimating density maps to directly predicting target points in images. To maximize the prediction certainty, the methods disclosed herein utilize the Shannon entropy formula as a loss objective function. In addition, the present disclosure relates to an adversarial learning scheme to motivate the deep learning network to produce similar distributional predictions over the source domain and the target domain. In the cross-domain setting, the method disclosed herein demonstrate substantial generalization compared to the previous crowd counting methods, and further performs estimating on a new chicken counting dataset.

Far apart from prior approaches that normally learn to predict a density map, the present disclosure, in some embodiments, illustrates a network to estimate location offset maps and classification maps directly. With the source domain samples, since labels are available, supervised Lebesgue-2 (L2) distance loss and cross entropy loss can be effortlessly calculated and ca be used to guide the network. On the other hand, since samples on the target domain do not have labels, some recent approaches utilize output from a teacher model as a pseudo-label with lower confidence to guide the learning process. The present disclosure, in certain embodiments, adopts the Shannon entropy formulation to be a loss function in order to encourage the deep network to produce a higher confidence score. To further narrow the domain gap, a discriminator, which is a fully convolutional neural network classifier, to motivate the network to extract similar distribution output over both domains may be utilized. This discriminator tries to determine which domain the input belongs to by learning domain classification, while the main network tries to make the discriminator produce fault predictions. The Shannon entropy loss and adversarial loss functions are added simultaneously to the main, fully supervised training process in order to teach the domain adaptation learning scheme.

### Self-Supervised Domain Adaptation by Entropy Minimization and Adversarial Learning

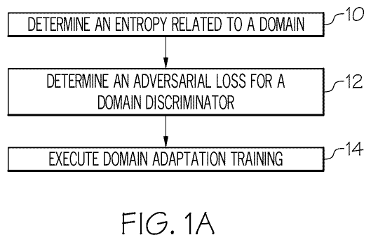

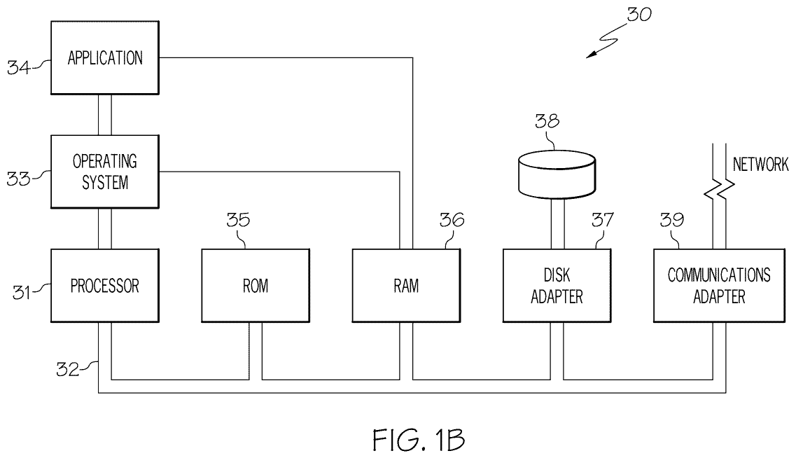

Various methods may be utilized to train a network for optimized learning. For example, in certain embodiments, the training may include self-supervised domain adaptation. In some embodiments, the self-supervised domain adaptation may use entropy minimization and/or adversarial learning. As an illustrative example, FIG. 1A shows a method of training a network via a source domain of labeled image samples and a target domain of unlabeled image samples, according to aspects of the disclosure.

At step 10, an entropy loss relating to a domain is determined. In certain embodiments, the domain may include, for example, a source domain and/or a target domain. In some embodiments, the source domain and/or the target domain may include various types of data. For example, in some embodiments, each domain may include one or more image samples. In certain embodiments, entropy loss may be determined by, for example, extracting a feature map related to the one or more image samples of the domain.

In certain embodiments, each cell of the feature map corresponds to a window size on the original input (e.g., the source domain). In some embodiments, a processed feature map, as discussed in detail below, two network branches may be used to predict a point coordinate and background-foreground classification. In some embodiments, the entropy loss may be determined by estimating an offset map and a classification map. In certain embodiments, the entropy loss may be determined by at least a portion of the classification map. In some embodiments, the offset map and/or the classification map may be based at least in part on the feature map.

In some embodiments, the offset map and/or the classification map may be estimated by predicting a point coordinate and a background-foreground classification as discussed above. In certain embodiments, the predicted background-foreground classification may include a predicted score of the point coordinate belonging to an object. In some embodiments, the offset map and the classification map may be estimated for each domain (e.g., the source domain and the target domain). In certain embodiments, the entropy loss for each domain may be based at least in part on the predicted background-foreground classification.

At step 12, an adversarial loss for a domain discriminator is determined. In certain embodiments, the domain discriminator may be configured to predict whether a given input belongs to a specific domain, such as, the source domain and/or the target domain. In some embodiments, the adversarial loss may be based on the offset map and/or the classification map for a specific domain (e.g., the target domain). In certain embodiments, the domain discriminator is trained to produce fault predictions.

At step 14, domain adaptation training of the network is executed. In certain embodiments, the domain adaptation training may use one or more of the entropy loss for the source domain, the entropy loss for the target domain, or the adversarial loss. Additionally, in some embodiments, the method may include calculating a supervised training loss for a domain, such as, the source domain. In some embodiments, the calculated supervised training loss may be calculated using, for example, the offset map for the source domain and the classification map for the source domain. In such embodiments, the method may include executing supervised training of the network using the supervised training loss.

In some embodiments, a distance loss may be determined using the predicted point coordinate for the source domain. In certain embodiments, a cross-entropy loss may be determined using the predicted background-foreground classification for the source domain. In some embodiments, the supervised training loss may be based at least in part on the distance loss and the cross-entropy loss.

### Computing Devices

The computing devices of the present disclosure can have various architectures. For instance, embodiments of the present disclosure as discussed herein may be implemented using a computing device 30 illustrated in FIG. 1B. Computing device 30 represents a hardware environment for practicing various embodiments of the present disclosure.

Computing device 30 has a processor 31 connected to various other components by system bus 32. An operating system 33 runs on processor 31 and provides control and coordinates the functions of the various components of FIG. 1B. An application 34 in accordance with the principles of the present disclosure runs in conjunction with operating system 33 and provides calls to operating system 33, where the calls implement the various functions or services to be performed by application 34. Application 34 may include, for example, a program for network training, such as in connection with FIGS. 1A, illustrating an example method to train a network via a source domain of labeled image samples and a target domain of unlabeled image samples.

Referring again to FIG. 1B, read-only memory (“ROM”) 35 is connected to system bus 32 and includes a basic input/output system (“BIOS”) that controls certain basic functions of computing device 30. Random access memory (“RAM”) 36 and disk adapter 37 are also connected to system bus 32. It should be noted that software components including operating system 33 and application 34 may be loaded into RAM 36, which may be computing device's 30 main memory for execution. Disk adapter 37 may be an integrated drive electronics (“IDE”) adapter that communicates with a disk unit 38 (e.g., a disk drive). It is noted that the program for network training, such as in connection with FIG. 1A, or similar embodiments, may reside in disk unit 38 or in application 34.

Computing device 30 may further include a communications adapter 39 connected to bus 32. Communications adapter 39 interconnects bus 32 with an outside network (e.g., wide area network) to communicate with other devices.

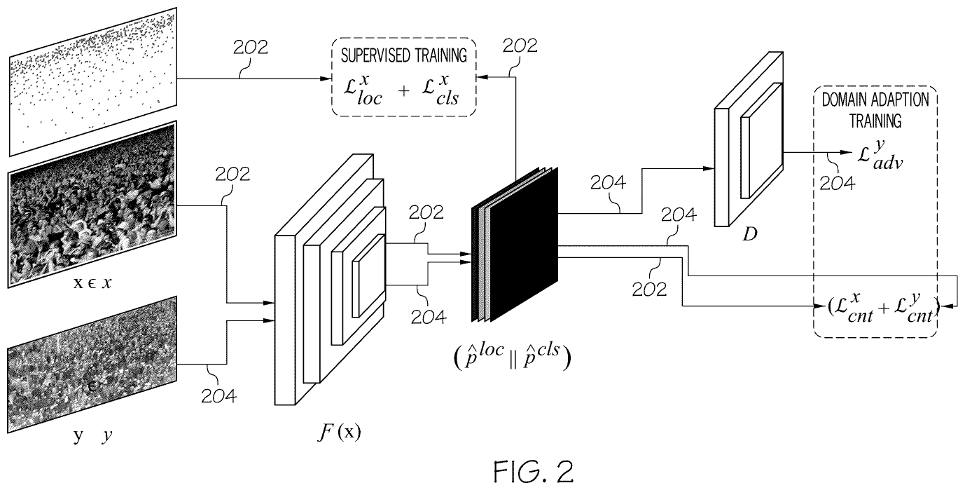

FIG. 2 illustrates a framework for various concepts described herein. Given an image sample, the deep network first extracts F(x) feature, then estimates location offset map and classification map (\hat{p}^{loc}, \hat{p}^{cls}). With source domain sample x∈X, since label is available, supervised L2 distance L_{loc}^{X} loss and cross-entropy L_{cls}^{X} loss can be effortlessly calculated, and they are used to guide the network. On the other hand, since sample on target domain y does not have label, Lₑₙₜ^{X}, Lₑₙₜ^{Y}, L_{adv}^{Y} loss functions are employed to additionally teach the domain adaptation learning process. Arrows 202 indicate source sample's learning flow, while arrows 204 indicate the learning flow of target sample.

Aspects of the present disclosure are described herein with reference to flowchart illustrations and/or block diagrams of methods, apparatus (systems), and computing devices according to embodiments of the disclosure. It will be understood that computer-readable program instructions can implement each block of the flowchart illustrations and/or block diagrams, and combinations of blocks in the flowchart illustrations and/or block diagrams.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks. The computer-readable program instructions may also be loaded onto a computer, other programmable data processing apparatus, or other devices to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computing devices according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### ADDITIONAL EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Self-Supervised Domain Adaptation in Crowd Counting

Self-training crowd counting has not been attentively explored though it is one of the important challenges in computer vision. In practice, the fully supervised methods usually require an intensive resource of manual annotation. To address this challenge, this example introduces a new approach to utilize existing datasets with ground truth to produce more robust predictions on unlabeled datasets, named domain adaptation, in crowd counting. While the network is trained with labeled data, samples without labels from the target domain are also added to the training process. In this process, the entropy map is computed and minimized in addition to the adversarial training process designed in parallel. Experiments on Shanghaitech, UCF_CC_50, and UCF-QNRF datasets prove a more generalized improvement of this method over the other state-of-the-arts in the cross-domain setting.

### Introduction

Crowd counting has recently been one of the popular tasks in computer vision. Recent developed methods and datasets have been introduced to tackle the counting task with thousands of targets. However, in real-world scenarios, these supervised methods usually learn to count through a training process that requires an extensive annotation of densely populated points in thousands of images. Directly employing models that are trained on existing datasets to a new dataset suffers from a significant performance decrease due to the domain gap.

Therefore, in addition to semantic scene understanding and video temporal modeling, some self-training methods appear to utilize existing datasets with labels (i.e., source domain) and perform counting on more open-set scenarios (i.e., target domain) by transfer learning and domain adaptation techniques. Knowledge distillation between both regression-based and detection-based models have been enabled by formulating the mutual transformation of outputs. The generalization over density variance has been enhanced by categorizing image patches into several density levels. While general self-learning methods improve the generalization capability by attempting to estimate pseudo ground-truths or distillation learning from a teacher network, a few approaches investigate a new direction to narrow the domain shift from entropy feedback of the target domain, especially in the semantic segmentation task.

In this example, Applicant introduces a new training approach to the crowd counting task toward a domain adaptation setting where the crowd counter utilizes the entropy minimization and adversarial learning to alleviate the distributional discrepancy between the source domain and the target domain. Particularly, the contributions can be summarized as follows: (1) Reformulate the crowd counting problem from normally estimating density map to directly predicting target points in images, inspired by anchor-based and offset-based approaches; (2) Utilize the Shannon entropy formula as a loss objective function to maximize the prediction certainty; (3) Design an adversarial learning scheme to motivate the network to produce similar distributional predictions over the source domain and the target domain; and (4) Evaluate the proposed method with cross-domain settings to demonstrate its substantial generalization compared against the previous crowd counting methods and further perform estimating on a new chicken counting dataset.

### Domain Adaptation for Crowd Counting

Point Proposal Network: Far apart from prior approaches that normally learn to predict a density map, this example designs a network to estimate head points directly. Given an RGB image x∈ [symbol] , the training source domain, the deep feature extracted from the backbone network [symbol] can be denoted as [symbol] (x) and its output size is W×H×D. [symbol] (x) involves a hyper-parameter s that is the backbone's downscale stride. Each cell on the feature map [symbol] (x) basically is correspondence to a window size s×s on the original input x. The maximum number of points that can exist in the window is D (point's index is denoted as k, k∈[0, D−1]). Then, given the processed feature map [symbol] (x), two network branches are adopted to predict the point coordinate (denoted as \hat{p}^{loc}) and background-foreground classification (denoted as \hat{p}^{cls}). From the location (i,j) where the pixel is located in the feature map [symbol] (x), the regression branch learns to estimate 2×k offset values (δᵢ_{ₖ}, δⱼ_{ₖ}) in the range [−1,1]. The point location \hat{p}_{i,j,k}^{loc}=(\hat{x}ₖ, ŷₖ) is computed as follows:

$${\hat{x}}_{k} = s ( i + {δ}_{{i}_{k}} ) \qquad ( 1 )$$

$${\hat{y}}_{k} = s ( j + {δ}_{{j}_{k}} )$$

In the classification task, two predicted scores belong to positive class posₖ (object's point) and negative class ne gₖ (background). The Softmax function is employed to normalize two confident scores \hat{p}_{i,j,k}^{cls}=( [symbol] ₖ^{pos}, [symbol] ₖ^{neg}) that follow a probability distribution whose total sums up to one:

$${\hat{cls}}_{k}^{pos} = \frac{{e}^{{pos}_{k}}}{{e}^{{pos}_{k}} + {e}^{{neg}_{k}}} \qquad ( 2 )$$

$${\hat{cls}}_{k}^{neg} = \frac{{e}^{{neg}_{k}}}{{e}^{{pos}_{k}} + {e}^{{neg}_{k}}}$$

Supervised Training Losses: On the source domain [symbol] where labels are provided, the supervised training losses on both branches are formulated as the standard ones. The [symbol] ₂ distance and Cross Entropy losses are adopted for the regression branch and the classification branch, respectively. Denoting pᵢ^{loc}, clsᵢ^{pos}, clsᵢ^{neg} as corresponding ground-truth values of \hat{p}ᵢ^{loc}, [symbol] ᵢ^{pos}, [symbol] ᵢ^{neg}, those loss functions are defined as follows:

$${ℒ}_{loc} ( x ) = \frac{1}{\vert N \vert} {\sum }_{i = 1}^{\vert N \vert} {‖ {\hat{p}}_{i}^{loc} - {p}_{i}^{loc} ‖}_{2} \qquad ( 3 )$$

$${ℒ}_{cls} ( x ) = - \frac{1}{\vert M \vert} {\sum }_{i = 1}^{\vert M \vert} ( {cls}_{i}^{pos} log {\hat{cls}}_{i}^{pos} + {cls}_{i}^{neg} log {\hat{cls}}_{i}^{neg} ) \qquad ( 4 )$$

where N is the set of points of the ground truth and M is the set of proposals containing both negative and positive pixel points. M can be obtained from a one-to-one matching strategy (i.e., Hungarian algorithm). Finally, the fully supervised training loss can be obtained as follows:

$${ℒ}_{loc}^{𝒳} + {ℒ}_{cls}^{𝒳} \qquad ( 5 )$$

where [symbol] denotes a particular loss calculated on all samples from the source domain [symbol] .

### Entropy Minimization on Target Domain

On the target domain [symbol] , where labels are not available, while some approaches utilize output from a teacher model as a pseudo-label with lower confidence to guide the learning process, entropy minimization is a preferable principle in self-training semantic segmentation demonstrated through a number of research works. By formulating the point's head classification similar to the semantic segmentation problem, the Shannon entropy formulation can be adopted to be a loss function in order to encourage the deep network to produce a higher confidence score. Given an RGB image y∈ [symbol] on the target domain, the classification per pixel entropy can be formulated as follows:

$${ε ( y )}_{i , j , k} = \frac{- 1}{log 2} ( {\hat{cls}}_{k}^{pos} log {\hat{cls}}_{k}^{pos} + {\hat{cls}}_{k}^{neg} log {\hat{cls}}_{k}^{neg} ) \qquad ( 6 )$$

And the self-training entropy loss can be defined as:

$${ℒ}_{ent} ( y ) = \frac{1}{W \times H \times D} {\sum }_{i}^{W} {\sum }_{j}^{H} {\sum }_{k}^{D} {ε ( y )}_{i , j , k} \qquad ( 7 )$$

### Distribution Discrepancy Minimization by Adversarial Learning

To further narrow the domain gap, a discriminator [symbol] was utilized, which is a fully convolutional neural network classifier, to motivate the network to extract similar distribution output over both domains. This discriminator tries to determine which domain the input belongs to by learning domain classification ( [symbol] ₓ, [symbol] _{y}), while the main network tries to make the discriminator produce fault predictions. Given the concatenation of offset and category maps from the network (\hat{p}^{loc}∥\hat{p}^{cls}), the loss function of the discriminator can be formulated as follows,

$${ℒ}_{dis} ( {\hat{p}}^{loc} ‖ {\hat{p}}^{cls} ) = - {\sum }_{i}^{W} {\sum }_{j}^{H} [ ( 1 - z ) log {𝒟}_{𝒳} ( {\hat{p}}^{loc} ‖ {\hat{p}}^{cls} ) + z log {𝒟}_{𝒴} ( {\hat{p}}^{loc} ‖ {\hat{p}}^{cls} ) ] \qquad ( 8 )$$

where z=0 if \hat{p}= [symbol] (x) or z=1 if \hat{p}≡ [symbol] (y), which x∈ [symbol] , y∈ [symbol] , and (.∥.) is the tensor concatenation operation.

Additionally, to narrow the produced distributions of source domain and the target domain, an adversarial loss was added in the main network's training process:

$${ℒ}_{adv} ( y ) = - {\sum }_{i}^{W} {\sum }_{j}^{H} [ log {𝒟}_{𝒳} ( {\hat{p}}_{y}^{loc} ‖ {\hat{p}}_{y}^{cls} ) ] \qquad ( 9 )$$

More specifically, the adversarial loss is designed to maximize the probability of the discriminator predicting source domain class given target domain samples y∈ [symbol] .

To summarize, the learning process of the main point proposal network involves Eqn. 3, 4, 7, and 9 loss functions:

$${λ}_{loc} {ℒ}_{loc}^{𝒳} + {λ}_{cls} {ℒ}_{cls}^{𝒳} + {λ}_{ent} ( {ℒ}_{ent}^{𝒳} + {ℒ}_{ent}^{𝒴} ) + {λ}_{adv} {ℒ}_{adv}^{𝒴} \qquad ( 10 )$$

where λ_{loc}, λ_{cis}, λₑₙₜ, lady are weighted parameters to balance corresponding objective functions, [symbol] and [symbol] denote particular losses calculated on all samples from domain [symbol] and [symbol] , respectively. In parallel, the discriminator [symbol] learns with the guidance of Eqn. 8:

$${ℒ}_{dis}^{𝒳} + {ℒ}_{dis}^{𝒴} \qquad ( 11 )$$

The entire training procedure is depicted as in FIG. 2.

Table 1 illustrates error rates comparison among loss components. Numbers in italic indicate error rates on source domain, while underlined numbers are results on adapted domain.

TABLE 1

| | |
|---|---|
| SHTechA | SHTechB |

| Components | MAE | MSE | MAE | MSE |
|---|---|---|---|---|
| Lₑₙₜ^{x} | 54.32 | 90.39 | 25.36 | 39.14 |
| | 162.78 | 289.47 | 7.92 | 11.53 |
| Lₑₙₜ^{y} | 60.76 | 95.34 | 22.03 | 34.27 |
| | 105.48 | 164.36 | 10.43 | 15.60 |
| Lₑₙₜ^{x} + Lₑₙₜ^{y} | 54.04 | 89.37 | 21.58 | 30.84 |
| | 87.76 | 126.53 | 8.03 | 11.98 |
| L_{adv}^{y} | 62.83 | 107.42 | 28.39 | 47.58 |
| | 174.59 | 302.87 | 15.57 | 27.38 |
| Lₑₙₜ^{x} + Lₑₙₜ^{y} + L_{adv}^{y} | 57.67 | 93.71 | 18.29 | 26.21 |
| | 69.21 | 95.36 | 8.72 | 12.53 |

Table 2 illustrates error rates comparison between the approach of the disclosure with other domain adaptation (DA) and supervised methods. Numbers in italic indicate error rates on source domain, while underlined numbers are results on adapted domain.

TABLE 2

| | |
|---|---|
| SHTechA | SHTechB |

| Method | DA | MAE | MSE | MAE | MSE |
|---|---|---|---|---|---|
| DM-Count | X | 60.04 | 96.01 | 22.91 | 34.69 |
| | | 142.00 | 241.02 | 7.33 | 11.87 |
| UEPNet | X | 55.26 | 91.94 | 24.36 | 37.22 |
| | | — | — | 6.38 | 10.88 |
| P2P | X | 53.02 | 88.48 | 21.91 | 33.86 |
| | | 158.30 | 267.51 | 6.55 | 9.50 |
| ConvNets | ✓ | 73.5 | 112.3 | 49.1 | 99.2 |
| | | 140.4 | 226.1 | 18.7 | 26.0 |
| SPN + L2SM | ✓ | 64.2 | 98.4 | 21.2 | 38.7 |
| | | 126.8 | 203.9 | 7.2 | 11.1 |
| RDBT | ✓ | — | — | 13.38 | 29.25 |
| | | 112.24 | 218.18 | — | — |
| Disclosure | ✓ | 57.67 | 93.71 | 18.29 | 26.21 |
| | | 69.21 | 95.36 | 8.72 | 12.53 |

### Ablation Study

To illustrate the effectiveness of each proposed objective loss in the method of this disclosure, Applicant conducted the ablative experiments as shown in Tab. 1. Applicant slightly added and removed their training strategies on top of the original supervised approach. The experimental results have shown that the proposed losses have achieved significant improvement.

### Comparison Against SOTA Methods on Public Datasets

The Shanghaitech Dataset is composed of two parts: Part-A and Part-B and it contains a total of 1,198 images of 330,165 people. Applicant used these two parts to take turns as source and target domains as shown in Tab. 2. In each method, the first row is using SHTechA for the source domain, SHTechB for the target domain, and the second row is trained in reversed order. The results show that, with domain adaptation learning, the method of the disclosure can be aware of the target's distribution and yields better quantitative results on its samples (69.21/95.36 vs 112.24/218.18 of RDBT on SHTechA), while the performance on source domain is not hurt (57.67/93.71 vs 53.02/88.48 on SHTechA and 8.72/12.53 vs 6.55/9.50 on SHTechB of P2P).

The UCF_CC_50 dataset and the UCF-QNRF dataset have a large variant number of head counts. While the former only contains 50 images but the number of head points varies from 94 to 4,543, the latter consists of 1,535 images with 1,251,642 point heads in total. Applicant used Shanghaitech Part-A for the source domain to adapt on these two datasets. The results also prove the method disclosed herein with domain adaptation perform superior quantitative results on target domain as shown in Tab. 3 (305.57/400.62 vs 332.4/425.0 of SPN+L2SM on UCF_CC_50) and (154.73/237.84 vs 227.2/405.2 of SPN+L2SM on UCF-QNRF).

Table 3 illustrates error rates comparison between the approach of this disclosure with other domain adaptation (DA) and supervised methods.

TABLE 3

| | | UCF_CC_50 | | UCF-QNRF | |
|---|---|---|---|---|---|
| Method | DA | MAE | MSE | MAE | MSE |
| DM-Count | X | 427.16 | 638.92 | 315.94 | 542.23 |
| ConvNets | ✓ | 364.0 | 545.8 | — | — |
| SPN + L2SM | ✓ | 332.4 | 425.0 | 227.2 | 405.2 |
| RDBT | ✓ | 368.01 | 518.92 | 175.02 | 294.76 |
| Disclosure | ✓ | 305.57 | 400.62 | 154.73 | 237.84 |

### Qualitative Result on Chicken Counting

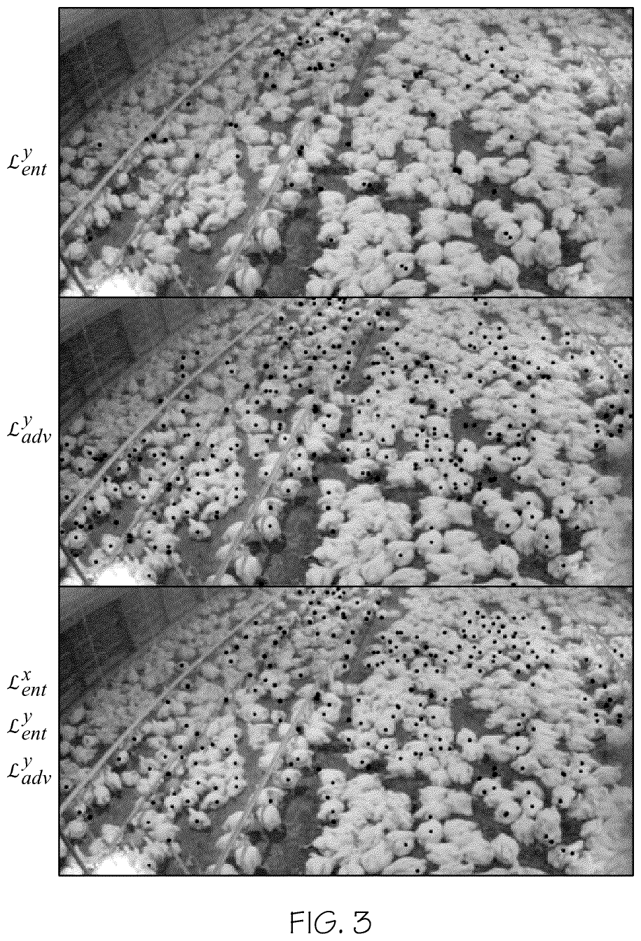

Applicant wanted to evaluate the proposed training method on the chicken dataset collected in farm scenes which have not been annotated as shown in FIG. 3. The dataset will be annotated and soon publicly release a test set for quantitative evaluation. Applicant trained the SHTech dataset as the source domain and tried different domain adaptation training strategies on this dataset.

The first row is the training process with entropy minimization on the target domain. Since the network is mainly guided to learn the localization and classification tasks from the human dataset, the network finds it difficult to recognize chickens as positive class and the result mostly returns false negatives. The second row is the training process with adversarial loss. While the distribution gap is narrower, resulting in more densely populated prediction, the network produces more false positives by trying to map the dense distribution of the source domain. The final training process balances those loss functions with weighted parameters and refines better results. However, it still does not yield optimal predictions and there are some missing counts caused by different lighting conditions (e.g., darker and brighter areas in top-left and bottom-left corners).

### CONCLUSION

In this example, Applicant has proposed a domain adaptation training scheme for the crowd counting task. The method of this disclosure is designed to minimize the domain gap between the source domain and the target domain through the entropy loss and the adversarial loss. The entropy minimization is computed on both domains while the adversarial objective minimizes the distribution discrepancy on target samples. As a result, the method shows better results on the target domain than recent self-training learning methods, while maintaining nearly the same error rates on the source domain. Furthermore, Applicant shows qualitative estimation on the chicken dataset which is used as the target domain. However, there are still some false negative counts on chickens, due to the lighting condition problem which is not fully addressed in this work.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A method of training a network via a source domain of labeled image samples and a target domain of unlabeled image samples, the method comprising, by a computer system:
determining, for each domain of the source domain and the target domain, an entropy loss related to the domain;
determining an adversarial loss for a domain discriminator configured to predict whether a given input belongs to the source domain or the target domain; and
executing domain adaptation training of the network using the entropy loss for the source domain, the entropy loss for the target domain, and the adversarial loss.

2. The method of claim 1, wherein determining the entropy loss comprises:
extracting a feature map related to one or more image samples of the domain; and
estimating an offset map and a classification map based at least in part on the feature map.

3. The method of claim 2, wherein the adversarial loss is based at least in part on the offset map and the classification map for the target domain.

4. The method of claim 2, wherein the entropy loss is determined by at least a portion of the classification map.

5. The method of claim 2, wherein the estimating comprises, for each domain of source domain and the target domain, predicting a point coordinate and a background-foreground classification, the predicted background-foreground classification comprising a predicted score of the point coordinate belonging to an object.

6. The method of claim 5, wherein, for each of the source domain and the target domain, the entropy loss is based at least in part on the predicted background-foreground classification.

7. The method of claim 5, comprising:
calculating a supervised training loss for the source domain using the offset map for the source domain and the classification map for the source domain; and
executing supervised training of the network using the supervised training loss.

8. The method of claim 7, comprising:
determining a distance loss using the predicted point coordinate for the source domain; and
determining a cross-entropy loss using the predicted background-foreground classification for the source domain, wherein the supervised training loss is based at least in part on the distance loss and the cross-entropy loss.

9. The method of claim 1, wherein the domain discriminator is trained to produce fault predictions.

10. A system comprising a processor and memory, wherein the processor and memory in combination are operable to perform a method of training a network via a source domain of labeled image samples and a target domain of unlabeled image samples, the method comprising:
determining, for each domain of the source domain and the target domain, an entropy loss related to the domain;
determining an adversarial loss for a domain discriminator configured to predict whether a given input belongs to the source domain or the target domain; and
executing domain adaptation training of the network using the entropy loss for the source domain, the entropy loss for the target domain, and the adversarial loss.

11. The system of claim 10, wherein determining the entropy loss comprises:
extracting a feature map related to one or more image samples of the domain; and
estimating an offset map and a classification map based at least in part on the feature map.

12. The system of claim 11, wherein the adversarial loss is based at least in part on the offset map and the classification map for the target domain.

13. The system of claim 11, wherein the entropy loss is determined by at least a portion of the classification map.

14. The system of claim 11, wherein the estimating comprises, for each domain of source domain and the target domain, predicting a point coordinate and a background-foreground classification, the predicted background-foreground classification comprising a predicted score of the point coordinate belonging to an object.

15. The system of claim 14, wherein, for each of the source domain and the target domain, the entropy loss is based at least in part on the predicted background-foreground classification.

16. The system of claim 15, comprising:
calculating a supervised training loss for the source domain using the offset map for the source domain and the classification map for the source domain; and
executing supervised training of the network using the supervised training loss.

17. The system of claim 16, comprising:
determining a distance loss using the predicted point coordinate for the source domain; and
determining a cross-entropy loss using the predicted background-foreground classification for the source domain, wherein the supervised training loss is based at least in part on the distance loss and the cross-entropy loss.

18. The system of claim 10, wherein the domain discriminator is trained to produce fault predictions.

19. A computer-program product comprising a non-transitory computer-usable medium having computer-readable program code embodied therein, the computer-readable program code adapted to be executed to implement a method for training a network via a source domain of labeled image samples and a target domain of unlabeled image samples, the method comprising:
for each domain of the source domain and the target domain:
extracting a feature map related to one or more image samples of the domain;
estimating an offset map and a classification map given the feature map; and
determining an entropy loss related to the domain using information related to the classification map;
determining an adversarial loss for a domain discriminator configured to predict whether a given input belongs to the source domain or the target domain, wherein the domain discriminator is trained to produce fault predictions; and
executing domain adaptation training of the network using the entropy loss for the source domain, the entropy loss for the target domain, and the adversarial loss.

20. The method of claim 19, comprising:
calculating a supervised training loss for the source domain using the offset map for the source domain and the classification map for the source domain; and
executing supervised training of the network using the supervised training loss.
